(19) United States
(12) Patent Application Publication
(10) Pub. No.: US 2015/0193335 A1
(43) Pub. Date: Jul. 9, 2015

(54) DISPLAY APPARATUS AND CONTROL METHOD THEREOF

(71) Applicant: SAMSUNG ELECTRONICS CO., LTD., Suwon-si (KR)

(72) Inventors: Chung-ki WOO, Seoul (KR); Jae-ook Kwon, Yongin-si (KR)

(73) Assignee: SAMSUNG ELECTRONICS CO., LTD., Suwon-si (KR)

(21) Appl. No.: 14/558,165

(22) Filed: Dec. 2, 2014

(30) Foreign Application Priority Data
Jan. 8, 2014 (KR) 10-2014-0002227

(51) Int. Cl. G06F 12/02

(52) U.S. Cl. CPC G06F 12/023; G06F 2212/1044

(57) ABSTRACT

A display apparatus includes a communicator configured to communicate with an external device, a first storage configured to store data processed by the display apparatus, and a controller configured to check an available capacity of the first storage if receiving a request for using the first storage from the external device, to store first data of the external device corresponding to the request in the first storage if the available capacity of the first storage is equal to or higher than a reference value, and not to store the first data of the external device in the first storage if the available capacity of the first storage is lower than the reference value.

### CROSS-REFERENCE TO RELATED APPLICATIONS

This application claims priority from Korean Patent Application No. 10-2014-0002227, filed on Jan. 8, 2014 in the Korean Intellectual Property Office, the disclosure of which is incorporated herein by reference.

### BACKGROUND

1. Field

Apparatuses and methods disclosed herein relate to a display apparatus and a control method thereof, and more particularly to a display apparatus, which operates while connecting with an external device through a network, and a control method thereof.

2. Description of the Related Art

A display apparatus such as a television (TV), a monitor, a computer, a smart phone, a smart pad, etc. may include a central processing unit (CPU) and a memory. The memory may be used to store a program currently running by the CPU and data, and to maintain a program or data obtained from the outside (externally). If the number of programs to be executed by the CPU increases and the memory is insufficient to store all the programs, programs not in use may be backed up and stored in another memory to thereby free up more memory.

Conventionally, the display apparatus has autonomously freed up more memory if it is out of memory as the number of programs to be executed by the CPU increases. For example, the display apparatus may add a memory to the existing memory or connect with a separate external memory device to make more memory available. However, such an autonomous method of the display apparatus has a limit to increase the capacity of the memory, and therefore the memory of the display apparatus is still insufficient.

Meanwhile, the display apparatus may operate while connecting with another display apparatus (hereinafter, also referred to as an ‘external device’) through a network in a home. For example, a moving image being displayed on a computer or a smart phone may be sent to a TV through Wi-Fi, so that the TV can display the moving image. Further, the display apparatus such as the TV may operate together with a set-top box (STB), a set-back box (SBB) or the like external device. However, the conventional display apparatus does not share memory with an external device even while it connects with the external device through the network and one of them is out of memory.

### SUMMARY

Additional aspects and/or advantages will be set forth in part in the description which follows and, in part, will be apparent from the description, or may be learned by practice of the disclosure.

According to an aspect of the disclosure, a display apparatus may include a communicator configured to (suitable for, capable of, adapted to, arranged to, operable to, etc.) communicate with an external device, a first storage configured to (suitable for, capable of, adapted to, arranged to, operable to, etc.) store data processed by the display apparatus, and a controller configured to (suitable for, capable of, adapted to, arranged to, operable to, etc.) check an available capacity of the first storage if receiving a request for using the first storage from the external device, to store first data of the external device corresponding to the request in the first storage if the available capacity of the first storage is equal to or higher than a reference value, and not to store the first data of the external device in the first storage if the available capacity of the first storage is lower than the reference value.

The controller may delete second data of the external device previously stored in the first storage if the available capacity of the first storage is less than the reference value.

The controller may control a plurality of pieces of second data previously stored in the first storage to be deleted in accordance with priorities (i.e., based on priority information of the pieces of second data).

The controller may transmit the second data of the external device previously stored in the first storage to the external device if the available capacity of the first storage is less than the reference value.

The controller may store (automatically and/or directly) the first data of the external device corresponding to the request in the first storage if the display apparatus is in a standby mode.

The controller may control the first data of the external device corresponding to the request to be stored in the first storage based on capacity information of the first storage, and the capacity information may correspond to or be based on a ratio of the available capacity to total capacity of the first storage.

The controller may compress the first data of the external device corresponding to the request and then store the compressed data in the first storage if the available capacity of the first storage is equal to or higher than the reference value.

The display apparatus may further include a second storage, and the controller may control data of the external device previously stored in the first storage to be stored in the second storage if the communicator is disconnected from the external device. The display apparatus may control the data of the external device previously stored in the second storage to be stored again in the first storage if the communicator resumes a connection with the external device.

According to an aspect of the disclosure, a method of controlling a display apparatus comprising a communicator to communicate with an external device, and a storage to store data processed by the display apparatus, may include receiving a request for using the storage from the external device, checking or determining an available capacity of the storage in response to the request, storing first data of the external device corresponding to the request in the storage if the available capacity of the storage is equal to or higher than a reference value, and preventing the first data of the external device from being stored in the storage if the available capacity of the storage is lower than the reference value.

The preventing the first data from being stored in the storage may include deleting second data of the external device previously stored in the storage.

The deleting the second data of the external device may include deleting a plurality of pieces of second data previously stored in the storage in accordance with priorities (i.e., based on priority information of the pieces of second data).

The preventing the first data from being stored in the storage may include transmitting the second data of the external device previously stored in the storage to the external device.

The checking the available capacity of the storage may include determining whether the display apparatus is in a standby mode, and storing the first data of the external device corresponding to the request in the storage if the display apparatus is in the standby mode.

The checking the available capacity of the storage may include controlling the first data of the external device corresponding to the request to be stored in the storage based on capacity information, where the capacity information may correspond to or be based on a ratio of the available capacity to total capacity of the storage.

The storing the first data in the storage may include compressing the first data of the external device corresponding to the request and then storing the compressed first data in the storage.

The method may further include separately storing data of the external device previously stored in the storage if the communicator is disconnected from the external device; and storing the separately stored data of the external device in the storage again if the communicator resumes a connection with the external device.

According to an aspect of the disclosure, a method of controlling a first electronic device in communication with an external electronic device may include receiving a request from the external electronic device to share a first storage of the first electronic device to store first data of the external electronic device, determining whether to store the first data in the first storage based on an operating mode of the first electronic device, and selectively storing the first data of the external electronic device corresponding to the request in the first storage based on the determining.

If the operating mode of the first electronic device corresponds to a standby mode, the first electronic device may automatically store the first data in the first storage. If the operating mode of the first electronic device does not correspond to the standby mode, the determining may further include determining whether to store the first data in the first storage based on capacity information of the first storage.

If the capacity information of the first storage indicates an available capacity of the first storage is equal to or greater than a predetermined reference value, the method may include storing the first data in the first storage, and if the capacity information of the first storage indicates an available capacity of the first storage is less than a predetermined reference value, the method may include preventing storage of the first data in the first storage.

The first electronic device and the external electronic device may be connected to each other over a network. If the first data is stored in the first storage based on the determining and the first electronic device is disconnected from the network, the method may further include storing second data in a second storage, the second data corresponding to data of the external electronic device stored in the first storage before the network was disconnected, reconnecting to the network and the external electronic device, and transferring the second data from the second storage to the first storage, after the first electronic device is reconnected to the network and the external electronic device.

According to an aspect of the disclosure, a non-transitory computer readable recording medium may store executable computer instructions, that when executed, cause a computer to implement the method of controlling a first electronic device in communication with an external electronic device and/or the method of controlling a display apparatus which communicates with the external device.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates a display apparatus and an external device according to an exemplary embodiment;

FIGS. 2 and 3 are block diagrams of the display apparatus according to an exemplary embodiment; and

FIGS. 4 to 11 are flowcharts showing operations of the display apparatus according to an exemplary embodiment.

### DETAILED DESCRIPTION

Reference will now be made in detail to the embodiments, examples of which are illustrated in the accompanying drawings, wherein like reference numerals refer to like elements throughout. The embodiments are described below to explain the disclosure by referring to the figures.

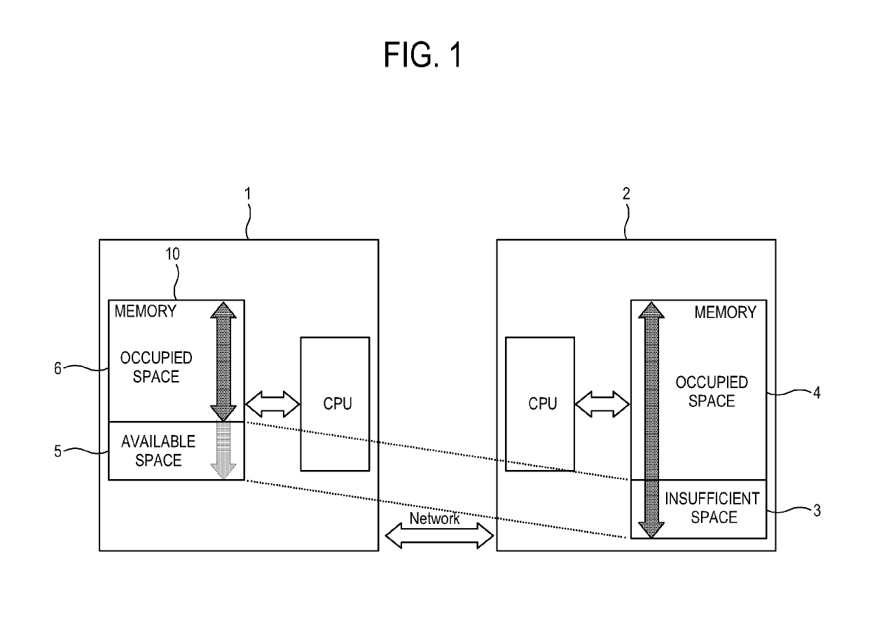

Below, exemplary embodiments will be described in detail. FIG. 1 illustrates a display apparatus 1 and an external device 2 according to an exemplary embodiment. The display apparatus 1 may be embodied by, for example, a television (TV), a monitor, a tablet personal computer (PC), a smart phone, etc. The external device 2 may be embodied by, for example, a TV, a monitor for a desktop computer, a tablet PC, a smart phone, a PC, a set-top box (STB), a set-back box (SBB), etc. The display apparatus 1 and the external device 2 may be connected to each other through a network, which may include a wired or wireless network or a combination thereof. The network may include a local area network (LAN), wireless local area network (WLAN), wide area network (WAN), personal area network (PAN), virtual private network (VPN), or the like. For example, wireless communication between elements of the example embodiments (e.g., the display apparatus 1 and the external device 2) may be performed via a wireless LAN, Wi-Fi, BLUETOOTH, ZIGBEE, WI-Fl DIRECT (WFD), ultra wideband (UWB), infrared data association (IrDA), BLUETOOTH low energy (BLE), near field communication (NFC), a radio frequency (RF) signal, and the like. For example, wired communication between elements of the example embodiments (e.g., the display apparatus 1 and the external device 2) may be performed via a pair cable, a coaxial cable, an optical fiber cable, an Ethernet cable, and the like.

The display apparatus 1 and the external device 2 may share a memory with each other. For example, if the memory of the external device 2 has an insufficient space 3 as an occupied space 4 increases, the external device 2 may share a memory 10 (hereinafter, referred to as a ‘storage’) of the display apparatus 1. If the occupied space 6 in the storage 10 of the display apparatus 1 is not so much that an available space 5 remains, the display apparatus 1 may allow the external device 2 to use the available space 5 of the storage 10. For example, memory that can be used by the external device 2, that is, the available capacity of the memory may be the sum of the occupied space 4 of the external device 2 and the available space 5 of the display apparatus 1. FIG. 1 illustrates an example that the external device 2 uses the memory of the display apparatus 1, but the disclosure is not limited thereto. Alternatively, the display apparatus 1 may use the memory of the external device 2. Also, this exemplary embodiment discloses sharing the memory, but the disclosure is not limited thereto. Alternatively, or additionally, the principle of the exemplary embodiment may be equally applied and/or extended to a central processing unit (CPU) or graphics processing unit (GPU) (hereinafter, referred to as the ‘CPU’). For example, if the CPU is insufficient as the usage of the CPU in the external device 2 increases, the external device 2 may share the CPU of the display apparatus 1. If the usage of the CPU in the display apparatus 1 is not so much that a remaining percentage of the CPU is available, the display apparatus 1 may allow the external device 2 to use the remaining percentage of the CPU. For example, the percentage of the CPU available in the external device 2 may be the sum of the usage of the CPU in the external device 2 and the remaining percentage of the display apparatus 1. Alternatively, the display apparatus 1 may additionally or alternatively use the CPU of the external device 2.

According to an exemplary embodiment, the display apparatus 1 may receive a request for using the storage 10 from the external device 2. The display apparatus may check the available space of the storage 10 in response to the request, thereby operating in accordance with the checked available space. For example, the display apparatus 1 may check whether an available capacity of the storage 10 is equal to or higher than a reference value. The display apparatus 1 may store data from the external device 2 in the storage when the capacity is equal to or higher than a reference value but the display apparatus 1 may not store data from the external device 2 when the capacity is lower than the reference value. Thus, whether to store the data of the external device 2 may be determined in accordance with the remaining capacity of the storage 10 in the display apparatus 1, so that the display apparatus 1 can smoothly operate while sharing the storage 10.

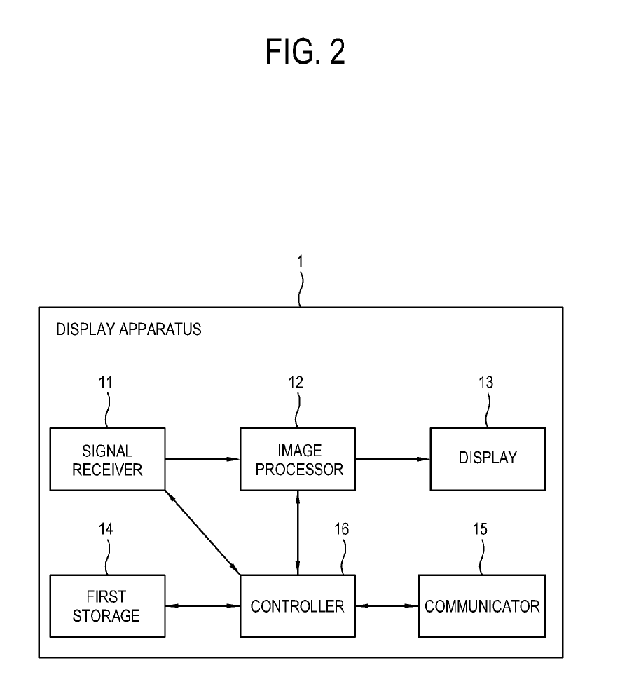

FIG. 2 is a block diagram of the display apparatus 1 according to an exemplary embodiment. The display apparatus 1 may include a signal receiver 11, an image processor 12, a display 13, a first storage 14, a communicator 15 and a controller 16.

The signal receiver 11 may receive an image signal. For example, the image signal may include a broadcasting signal for a TV. The broadcasting signal may be broadcasted through airwave broadcasting, cable broadcasting, satellite broadcasting, etc. There are broadcasting signals corresponding to a plurality of channels. The signal receiver 11 may receive a broadcasting signal through at least one channel selected by a user among the plurality of channels. According to another exemplary embodiment, an image signal may for example be received from an imaging device such as a digital versatile disc (DVD) player, a blu-ray disc (BD) player, etc., received from a PC, received through a network such as Internet, received through a network such as Bluetooth or Wi-Fi, and/or received from a memory such as a universal serial bus (USB) storage medium.

The image processor 12 may process a received image signal to be displayed as an image on the display 13. For example, the image processor 12 may perform modulation, demodulation, multiplexing, demultiplexing, analog-digital conversion, digital-analog conversion, decoding, encoding, image enhancement, scaling, etc. with respect to the received image signal.

The display 13 may display an image based on the image signal processed by the image processor 12. The display 13 may be embodied by, for example, one or more of various panel types such as a liquid crystal display (LCD), a light emitting diode (LED) display, a plasma display panel (PDP), an organic light emitting diode (OLED) display, flexible display, 3D display, and the like, to display an image. However, the disclosure is not limited to these example displays and may include other types of displays. The first storage 14 may be a volatile memory such as a random access memory (RAM) to store data or information of a program needed for operations of the display apparatus 1. For example, the volatile memory may be embodied as a dynamic RAM (DRAM), static RAM (SRAM), double data rate synchronous dynamic RAM (DDR SDRAM), and the like.

The communicator 15 may perform short-range wireless communication such as ZIGBEE, BLUETOOTH, near field communication (NFC), wireless personal area network (WPAN), etc. with the external device 2. The communicator 15 may receive a request for using the first storage 14 from the external device 2, and may receive data to be stored in the first storage 14 from the external device 2 or transmit the previously stored data of the external device 2 to the external device 2 in accordance with the request.

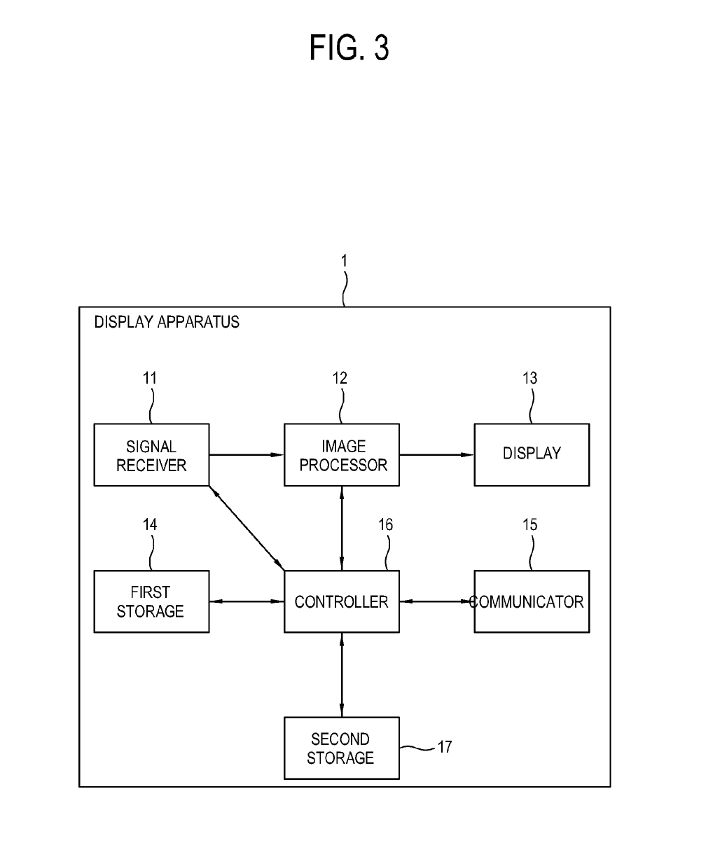

FIG. 3 is a block diagram of the display apparatus 1 according to an exemplary embodiment. The display apparatus 1 of FIG. 3 may include a second storage 17 in addition to the signal receiver 11, the image processor 12, the display 13, the first storage 14, the communicator 15 and the controller 16.

The second storage 17 may include a flash memory, a hard disk drive or the like nonvolatile memory, and may store data or information of a program needed for operations of the display apparatus 1. Other types of nonvolatile memory may include a Read Only Memory (ROM), Programmable Read Only Memory (PROM), Erasable Programmable Read Only Memory (EPROM), a USB drive, floppy disks, magnetic tape, a blue-ray disk, or optical media such as CD ROM discs and DVDs, or combinations thereof.

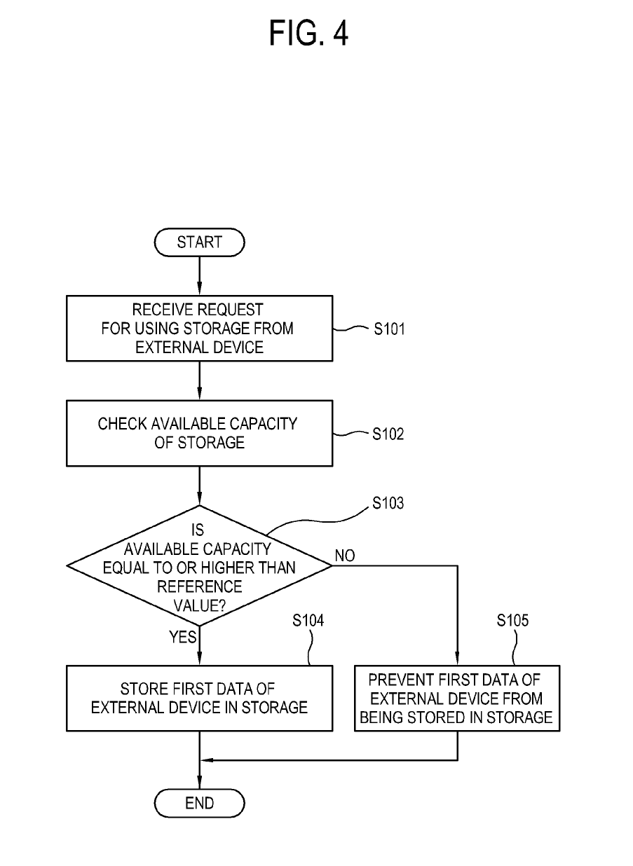

FIG. 4 is a flowchart showing operations of the display apparatus 1 according to an exemplary embodiment. Referring to FIG. 4, it will be described that the display apparatus 1 operates by receiving a request for using the first storage 14 from the external device 2. At operation S101, the communicator 15 receives a request for using the first storage 14 from the external device 2. Next, at operation S102, the controller 16 checks the available capacity of the first storage 14. Next, at operation S103, the controller 16 determines whether the available capacity of the first storage 14 is equal to or higher than a reference value. If the available capacity of the first storage 14 is equal to or higher than the reference value, at operation S104 the controller 16 stores the data of the external device 2 in the first storage 14. If the available capacity is lower than the reference value, at operation S105 the controller 16 does not store the data of the external device 2 in the first storage 14. That is, the display apparatus 1 may share the memory with the external device 2 only when the first storage 14 of the display apparatus 1 has an available capacity equal to or higher than a reference value and has a remaining space sufficient so as not to affect the current operations of the display apparatus 1. Thus, the operations of the display apparatus 1 are not affected by memory sharing. For example, the display apparatus 1 may determine whether the first storage 14 has an available capacity equal to or greater than the reference value based on whether a size of the available capacity is greater than a predetermined amount, or based on whether the available capacity is equal to or greater than a predetermined percentage of the total capacity of the first storage 14. The display apparatus 1 may further limit an amount of available capacity by a buffer amount or safety margin, for example, so as not to affect the current operations of the display apparatus 1.

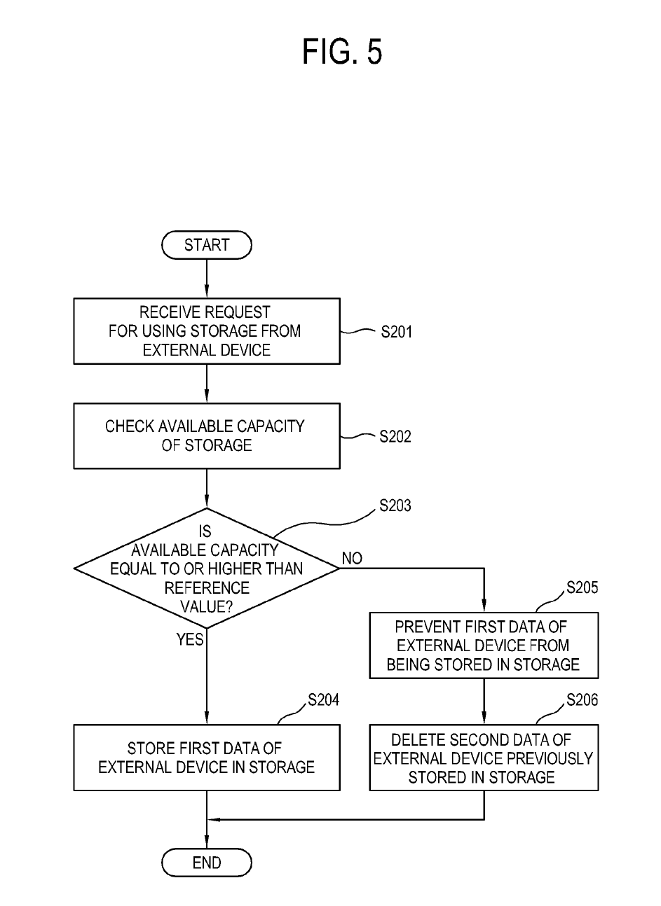

FIG. 5 is a flowchart showing operations of the display apparatus 1 according to an exemplary embodiment. Referring to FIG. 5, it will be described that the display apparatus 1 operates by receiving a request for using the first storage 14 from the external device 2. Operations S201 to S204 are the same as the operations S101 to S104 as shown in FIG. 4. Next, if the available capacity is lower than the reference value, at operation S205 the controller 16 does not store first data of the external device 2 in the first storage 14 (S205). If second data of the external device 2 has been previously stored in the first storage 14 of the display apparatus 1, at operation S206 the second data of the external device 2 previously stored in the first storage 14 is deleted. That is, when the first storage 14 of the display apparatus 1 has an available capacity lower than the reference value, the display apparatus 1 not only does not store the first data of the external device 2, but also deletes the second data stored by a previous request of the external device 2 from the first storage 14, thereby partially securing the available capacity of the display apparatus 1 and allowing the display apparatus 1 to smoothly continue to operate.

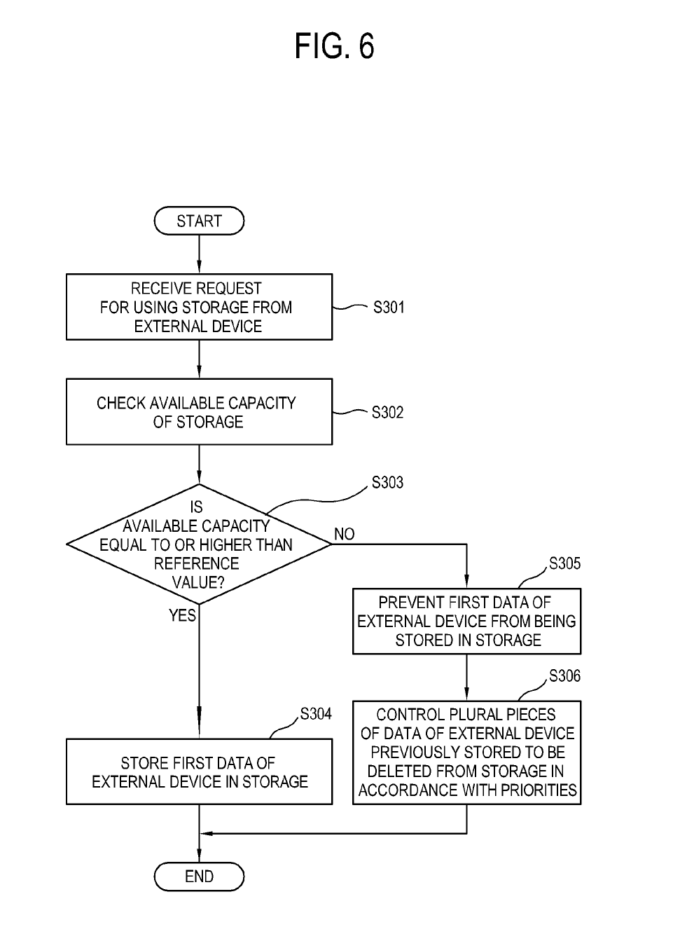

FIG. 6 is a flowchart showing operations of the display apparatus 1 according to an exemplary embodiment. Referring to FIG. 6, it will be described that the display apparatus 1 operates by receiving a request for using the first storage 14 from the external device 2. Operations S301 to S304 are the same as the operations S101 to S104 shown in FIG. 4. Next, if the available capacity is lower than the reference value, at operation S305 the controller 16 does not store first data of the external device 2 in the first storage 14. If a plurality of pieces of second data has been previously stored in the first storage 14 of the display apparatus 1, the plurality of pieces of second data may be deleted in accordance with priorities (S306). Here, the priorities for the plurality of pieces of second data may be determined in accordance with the respective attributes of the plurality of pieces of previously stored second data. For example, the second data may be determined to have higher priority if the data is more frequently and importantly used in the external device 2. That is, a priority of a piece of data may depend on, or be determined according to, a usage frequency of the piece of data. The usage frequency may be based on the total number of uses, or the frequency of usage over a preset time period (e.g., the number of uses in a recent time period). Alternatively, or additionally, a priority of a piece of data may depend on, or be determined according to, other characteristics or attributes of the piece of data, such as time information (when the piece of data was created, obtained, last accessed, modified, stored in the first storage 14, etc.), size information (how large or small the piece of data is), and the like. Accordingly, when the first storage 14 of the display apparatus 1 has an available capacity lower than the reference value, the display apparatus 1 not only does not store the first data of the external device 2, but also deletes the second data stored by a previous request of the external device 2 from the first storage 14 in accordance with the priorities (which may be predetermined), thereby partially securing the available capacity of the display apparatus 1 and allowing the display apparatus 1 to smoothly continue to operate.

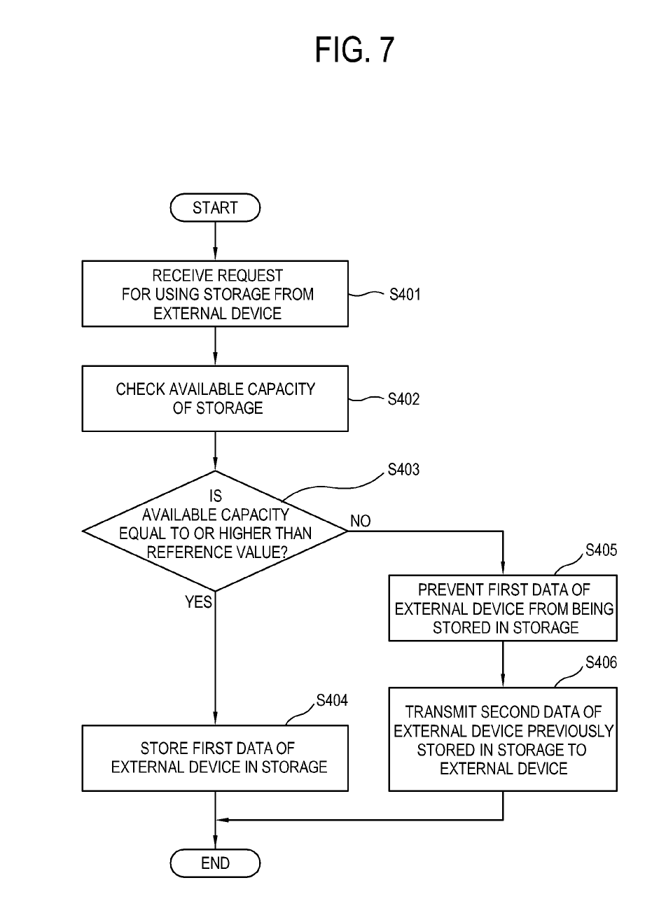

FIG. 7 is a flowchart showing operations of the display apparatus 1 according to an exemplary embodiment. Referring to FIG. 7, it will be described that the display apparatus 1 operates by receiving a request for using the first storage 14 from the external device 2. Operations S401 to S404 are the same as the operations S101 to S104 shown in FIG. 4. Next, if the available capacity is lower than the reference value, at operation S405 the controller 16 does not store first data of the external device 2 in the first storage 14. If second data of the external device 2 has been previously stored in the first storage 14 of the display apparatus 1, the second data of the external device 2 previously stored in the first storage 14 may be transmitted to the external device 2 (S406). That is, when the first storage 14 of the display apparatus 1 has an available capacity lower than the reference value, the display apparatus 1 not only does not store the first data of the external device 2, but also transmits the second data stored by a previous request of the external device 2 from the first storage 14 to the external device 2, thereby partially securing the available capacity of the display apparatus 1 and allowing the display apparatus 1 to smoothly continue to operate. Additionally, the display apparatus 1 may perform a combination of operations in accordance with the embodiments of FIGS. 5 and 6. That is, the display apparatus 1 may delete certain second data previously stored in the first storage 14, and may transmit certain remaining second data previously stored in the first storage 14 to the external device 2. For example, the display apparatus 1 may delete second data previously stored in the first storage 14 which has a predetermined priority (e.g., a relatively low priority), and may transmit certain remaining second data previously stored in the first storage 14 to the external device 2 which has a different predetermined priority (e.g., a relatively higher priority). The display apparatus 1 may also transmit second data to a device other than the external device 2 (e.g., a server, a database, or another external device). Thus, aspects of the embodiments disclosed with respect to FIGS. 5 through 6 may be applied to the display apparatus 1 of FIG. 7.

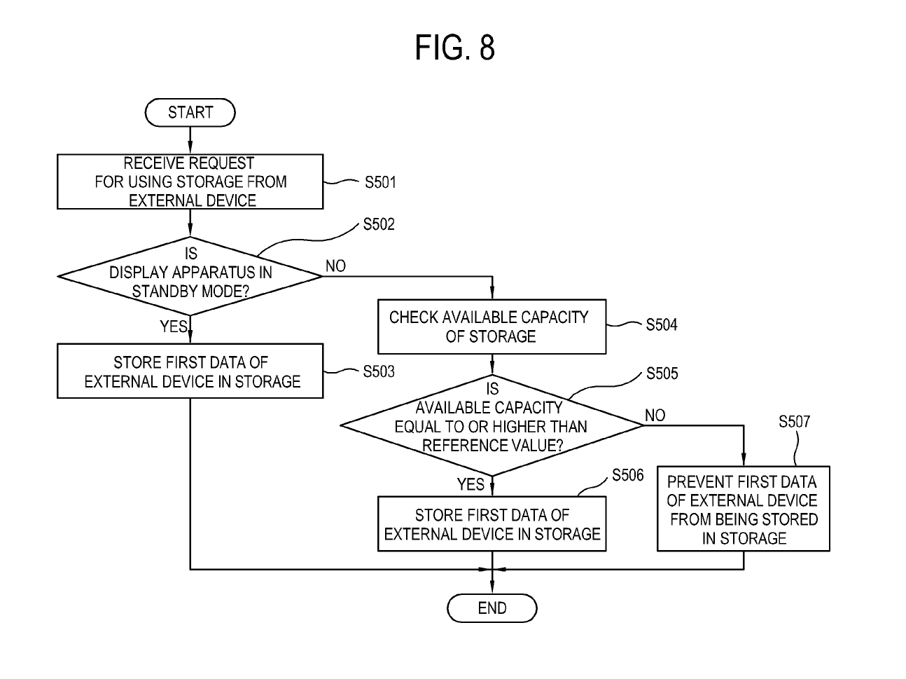

FIG. 8 is a flowchart showing operations of the display apparatus 1 according to an exemplary embodiment. Referring to FIG. 8, it will be described that the display apparatus 1 operates by receiving a request for using the first storage 14 from the external device 2. At operation S501 the communicator 15 receives a request for using the first storage 14 from the external device 2. Next, it is determined at operation S502 whether the display apparatus 1 is in a standby mode. If the display apparatus 1 is in the standby mode, at operation S503 the controller 16 stores the first data of the external device 2 in the first storage 14. On the other hand, if the display apparatus 1 is not in the standby mode, at operation S504 the controller 16 checks the available capacity of the first storage 14. Next, at operation S505 the controller 16 determines whether the available capacity of the first storage 14 is equal to or higher than the reference value. If the available capacity is equal to higher than the reference value, at operation S506 the controller 16 stores the first data of the external device 2 in the first storage 14. If the available capacity is lower than the reference value, at operation S507 the controller 16 does not store the first data of the external device 2 in the first storage 14. That is, when the display apparatus 1 is in the standby mode, only the minimum operations are performed and it is therefore determined that the available capacity of the display apparatus 1 is equal to or higher than the reference value and sufficient, thereby allowing or enabling the external device 2 to directly store the first data of the external device 2 in the first storage 14. Also, when not in the standby mode, the display apparatus 1 shares the memory with the external device 2 only when the first storage 14 of the display apparatus 1 has an available capacity equal to or higher than a reference value and has a remaining space sufficient not to affect the current operations of the display apparatus 1. Thus, the operations of the display apparatus 1 are not affected by memory sharing. Additionally, the display apparatus 1 of FIG. 8 may further perform one or more of the operations disclosed in accordance with the embodiments of FIGS. 5 through 7. That is, if the available capacity is lower than the reference value, at operation S507 the controller 16 may not store the first data of the external device 2 in the first storage 14 of the display apparatus 1. Further, the controller 16 may delete second data previously stored in the first storage 14, as disclosed with respect to FIG. 5, may delete pieces of second data previously stored in the first storage 14 based on priority information, as disclosed with respect to FIG. 6, and/or may transmit second data from the first storage 14 to the external device 2, as disclosed with respect to FIG. 7. Thus, aspects of the embodiments disclosed with respect to FIGS. 5 through 7 may be applied to the display apparatus 1 of FIG. 8.

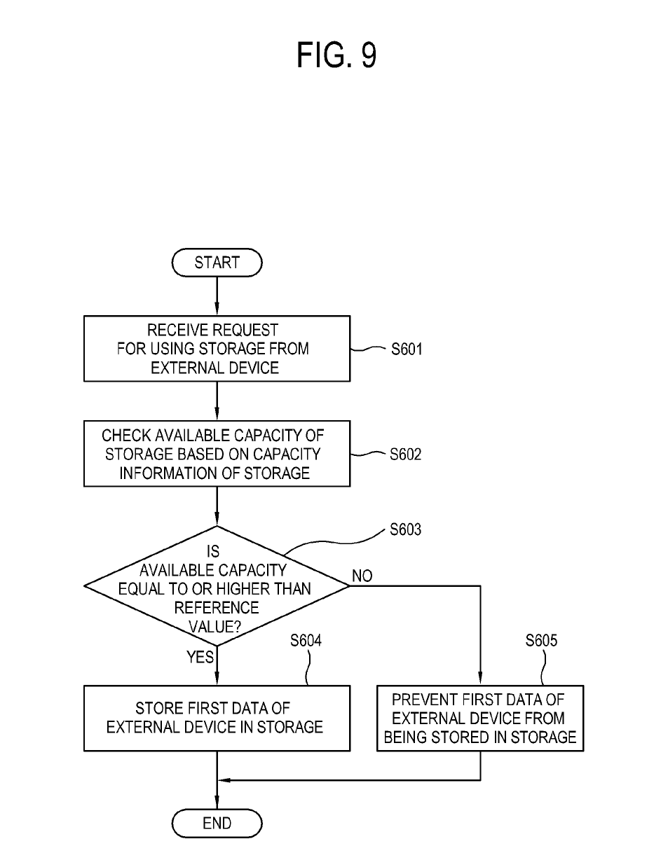

FIG. 9 is a flowchart showing operations of the display apparatus 1 according to an exemplary embodiment. Referring to FIG. 9, it will be described that the display apparatus 1 operates by receiving a request for using the first storage 14 from the external device 2. At operation S601 the communicator 15 receives a request for using the first storage 14 from the external device 2. Next, at operation S602, the controller 16 checks the available capacity based on capacity information of the first storage 14. Next, at operation S603, the controller 16 determines whether the available capacity of the first storage 14 is equal to or higher than the reference value. If the available capacity is equal to or higher than the reference value, the controller 16 stores the first data of the external device 2 in the first storage 14 (S604). If the available capacity is lower than the reference value, the controller 16 does not store the first data of the external device 2 in the first storage 14 (S605). That is, it is possible to more accurately check the available capacity of the first storage 14 based on a ratio of the available capacity to the total capacity of the first storage 14. Also, the display apparatus 1 shares the memory with the external device 2 only when the first storage 14 of the display apparatus 1 has an available capacity equal to or higher than a reference value and has a remaining space sufficient not to affect the current operations of the display apparatus 1. Thus, the operations of the display apparatus 1 are not affected by memory sharing. Additionally, the display apparatus 1 of FIG. 9 may further perform one or more of the operations disclosed in accordance with the embodiments of FIGS. 5 through 8. That is, the display apparatus 1 of FIG. 9 determines at operation S603 whether the available capacity is lower than a reference value based on capacity information of storage (e.g., based on ratio information obtained as a function of available capacity to total capacity of the first storage 14). If the available capacity is lower than the reference value, at operation S605 the controller 16 may not store the first data of the external device 2 in the first storage 14 of the display apparatus 1. Further, the controller 16 may delete second data previously stored in the first storage 14, as disclosed with respect to FIG. 5, may delete pieces of second data previously stored in the first storage 14 based on priority information, as disclosed with respect to FIG. 6, and/or may transmit second data from the first storage 14 to the external device 2, as disclosed with respect to FIG. 7. Further, when the display apparatus 1 is in the standby mode, it may be inferred or assumed that the available capacity of the display apparatus 1 is equal to or higher than the reference value, thereby allowing or enabling the external device 2 to directly store the first data of the external device 2 in the first storage 14, without checking the available capacity of the first storage 14, as disclosed with respect to FIG. 8. Thus, aspects of the embodiments disclosed with respect to FIGS. 5 through 8 may be applied to the display apparatus 1 of FIG. 9.

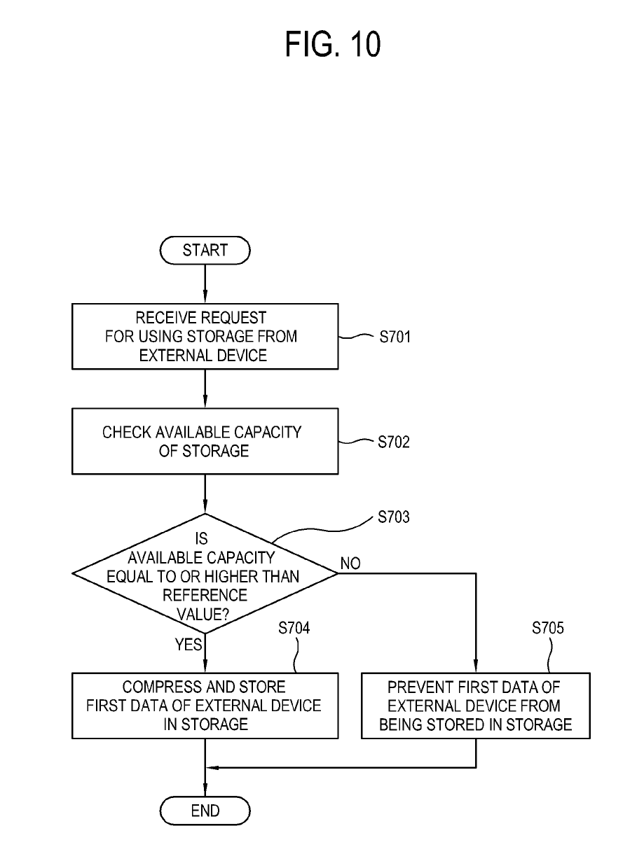

FIG. 10 is a flowchart showing operations of the display apparatus 1 according to an exemplary embodiment. Referring to FIG. 10, it will be described that the display apparatus 1 operates by receiving a request for using the first storage 14 from the external device 2. Operations S701 and S702 are the same as the operations S101 and S102. Next, at operation S703, the controller 16 determines whether the available capacity of the first storage 14 is equal to or higher than the reference value. If the available capacity is equal to or higher than the reference value, at operation S704 the controller 16 compresses the first data of the external device 2 and stores it in the first storage 14. On the other hand, if the available capacity is lower than the reference value, the controller 16 does not store the first data of the external device 2 in the first storage 14 (S705). That is, the first data of the external device 2 may be compressed and then stored in the first storage 14 of the display apparatus 1. Therefore, the occupied space of the first storage 14 can be less than the memory of the display apparatus 1 which would actually be shared by the external device 2 the display apparatus 1 without such compression. Additionally, the display apparatus 1 of FIG. 10 may further perform one or more of the operations disclosed in accordance with the embodiments of FIGS. 5 through 9. That is, at operation S704 the display apparatus 1 of FIG. 10 performs compression and stores first data in the first storage 14 when it is determined the available capacity is equal to or greater than a reference value based on an available capacity of the first storage 14. If the available capacity is lower than the reference value, at operation S705 the controller 16 may not store the first data of the external device 2 in the first storage 14 of the display apparatus 1. Further, the controller 16 may delete second data previously stored in the first storage 14, as disclosed with respect to FIG. 5, may delete pieces of second data previously stored in the first storage 14 based on priority information, as disclosed with respect to FIG. 6, and/or may transmit second data from the first storage 14 to the external device 2, as disclosed with respect to FIG. 7. Further, when the display apparatus 1 is in the standby mode, it may be inferred or assumed that the available capacity of the display apparatus 1 is equal to or higher than the reference value, thereby allowing or enabling the external device 2 to directly compress and store the first data of the external device 2 in the first storage 14, without checking the available capacity of the first storage 14, as disclosed with respect to FIG. 8. Further, the display apparatus 1 may determine whether the available capacity is lower than a reference value based on capacity information of storage (e.g., based on ratio information obtained as a function of available capacity to total capacity of the first storage 14), as disclosed with respect to FIG. 9. Thus, aspects of the embodiments disclosed with respect to FIGS. 5 through 9 may be applied to the display apparatus 1 of FIG. 10.

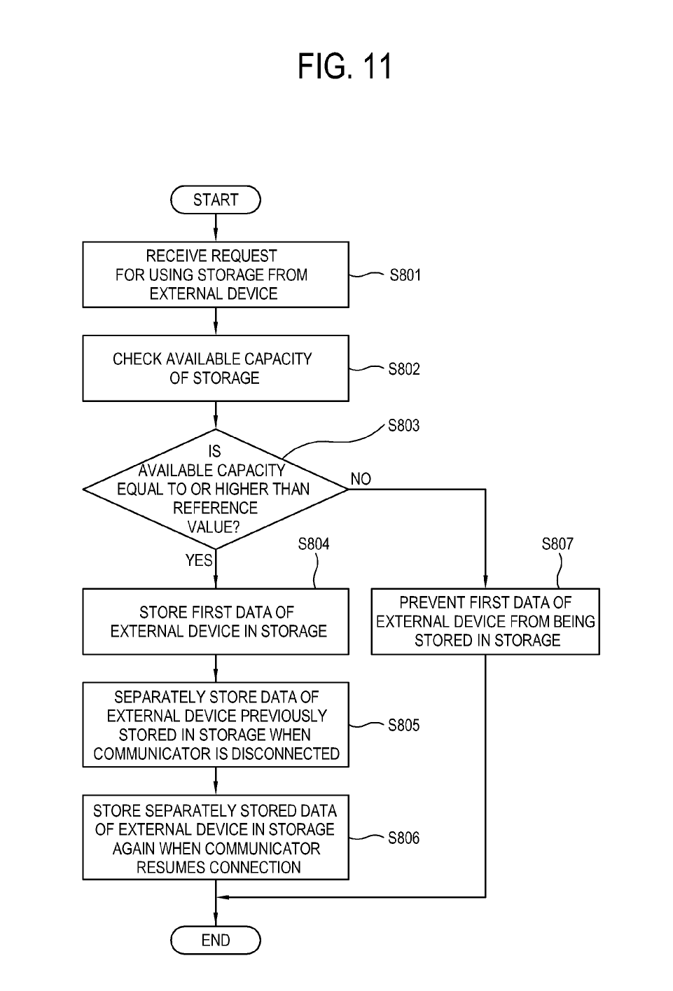

FIG. 11 is a flowchart showing operations of the display apparatus 1 according to an exemplary embodiment. Referring to FIG. 11, it will be described that the display apparatus 1 operates by receiving a request for using the first storage 14 from the external device 2. Operations S801 and S802 are the same as the operations S101 and S102. Next, at operation S803, the controller 16 determines whether the available capacity of the first storage 14 is equal to or higher than the reference value. If the available capacity is equal or higher than the reference value, the controller 16 stores the first data of the external device 2 in the first storage 14 (S804). Next, at operation S805 if the communicator 15 is disconnected from the network, the controller 16 may control the data of the external device 2 previously stored in the first storage 14 to be separately stored in the second storage 17. Next, at operation S806, if the communicator 15 resumes a connection with the network, the controller 16 may control the data of the external device 2 separately stored in the second storage 17 to be stored again in the first storage 14. If the available capacity is less than the reference value, at operation S807 the controller 16 does not store the first data of the external device 2 in the first storage 14. That is, when the display apparatus 1 is disconnected from the network, the data of the external device 2 stored in the first storage 14 (e.g., which may be embodied as a volatile memory) is backed up to the second storage 17 (e.g., which may be embodied as a nonvolatile memory). When the display apparatus 1 resumes a connection with the network, the data of the external device 2 stored in the second storage 17 may be stored again in the first storage 14. Therefore, the data of the external device 2 stored in the memory of the display apparatus may be prevented from loss even when the display apparatus 1 is in an unavoidable condition of disconnecting from the network. Additionally, the display apparatus 1 of FIG. 11 may further perform one or more of the operations disclosed in accordance with the embodiments of FIGS. 5 through 10. For example, if the available capacity is lower than the reference value, at operation S807 the controller 16 may not store the first data of the external device 2 in the first storage 14 of the display apparatus 1. Further, the controller 16 may delete second data previously stored in the first storage 14, as disclosed with respect to FIG. 5, may delete pieces of second data previously stored in the first storage 14 based on priority information, as disclosed with respect to FIG. 6, and/or may transmit second data from the first storage 14 to the external device 2, as disclosed with respect to FIG. 7. Further, when the display apparatus 1 is in the standby mode, it may be inferred or assumed that the available capacity of the display apparatus 1 is equal to or higher than the reference value, thereby allowing or enabling the external device 2 to directly store the first data of the external device 2 in the first storage 14, without checking the available capacity of the first storage 14, as disclosed with respect to FIG. 8. Further, the display apparatus 1 may determine whether the available capacity is lower than a reference value based on capacity information of storage (e.g., based on ratio information obtained as a function of available capacity to total capacity of the first storage 14), as disclosed with respect to FIG. 9. Further, the display apparatus 1 of FIG. 11 may perform compression and store first data in the first storage 14 when it is determined the available capacity is equal to or greater than a reference value based on an available capacity of the first storage 14, as disclosed with respect to FIG. 10. Thus, aspects of the embodiments disclosed with respect to FIGS. 5 through 10 may be applied to the display apparatus 1 of FIG. 11.

The example embodiments of FIGS. 4 through 11 have been described above with respect to an external device 2 using the memory of the display apparatus 1. However, the example embodiments of FIGS. 4 through 11 may equally be applied from the point of view of the display apparatus 1 using the memory of the external device 2. Further, as would be understood by one of ordinary skill in the art, aspects of the example embodiments of FIGS. 4 through 11 may also be applied to sharing of one or more processors between a display apparatus and an external device.

As described above, according to exemplary embodiments, a display apparatus capable of communicating with an external device through a network can share memory with the external device.

Further, according to exemplary embodiments, a display apparatus capable of communicating with an external device through a network can more effectively share memory with the external device.

The apparatuses and methods according to the above-described example embodiments may use one or more processors. For example, a processing device may be implemented using one or more general-purpose or special purpose computers, and may include, for example, one or more of a processor, a controller and an arithmetic logic unit, a central processing unit (CPU), a graphics processing unit (GPU), a digital signal processor (DSP), a microcomputer, a field programmable array, a programmable logic unit, an application-specific integrated circuit (ASIC), a microprocessor or any other device capable of responding to and executing instructions in a defined manner.

Aspects of the above-described example embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, USB memory, and the like. Examples of program instructions include both machine code, such as produced by a compiler, and files containing higher level code that may be executed by the computer using an interpreter. The program instructions may be executed by one or more processors. The described hardware devices may be configured to act as one or more software modules in order to perform the operations of the above-described embodiments, or vice versa. In addition, a non-transitory computer-readable storage medium may be distributed among computer systems connected through a network and computer-readable codes or program instructions may be stored and executed in a decentralized manner. In addition, the computer-readable storage media may also be embodied in at least one application specific integrated circuit (ASIC) or Field Programmable Gate Array (FPGA).

Although exemplary embodiments have been shown and described, it will be appreciated by those skilled in the art that changes may be made to these exemplary embodiments without departing from the principles and spirit of the disclosure. Therefore, the foregoing has to be considered as illustrative only. The scope of the claimed subject matter is defined in the appended claims and their equivalents. Accordingly, all suitable modification and equivalents may fall within the scope of the claimed subject matter.

What is claimed is:

1. A display apparatus, comprising:
a communicator to communicate with an external device;
a first storage to store data processed by the display apparatus; and
a controller to determine whether a first storage has available capacity in response to a request from the external device to use the first storage, to store first data of the external device corresponding to the request in the first storage if the available capacity of the first storage is equal to or higher than a reference value, and not to store the first data of the external device in the first storage if the available capacity of the first storage is lower than the reference value.

2. The display apparatus according to claim 1, wherein the controller deletes second data of the external device previously stored in the first storage if the available capacity of the first storage is less than the reference value.

3. The display apparatus according to claim 2, wherein the controller controls a plurality of pieces of second data previously stored in the first storage to be deleted based on priority information of the plurality of pieces of second data.

4. The display apparatus according to claim 1, wherein the controller transmits second data of the external device previously stored in the first storage to the external device if the available capacity of the first storage is less than the reference value.

5. The display apparatus according to claim 1, wherein the controller stores the first data of the external device corresponding to the request in the first storage if the display apparatus is in a standby mode.

6. The display apparatus according to claim 1, wherein the controller determines whether the first storage has available capacity to store the first data of the external device corresponding to the request based on capacity information of the first storage, and
the capacity information comprises a ratio of the available capacity of the first storage to total capacity of the first storage.

7. The display apparatus according to claim 1, wherein if the available capacity of the first storage is equal to or higher than the reference value, the controller compresses the first data of the external device corresponding to the request and then stores the compressed data in the first storage.

8. The display apparatus according to claim 1, further comprising a second storage,
wherein if the communicator is disconnected from the external device, the controller controls data of the external device previously stored in the first storage to be stored in the second storage, and
when the communicator resumes a connection with the external device, the controller controls the data stored in the second storage which was previously stored in the first storage, to be stored again in the first storage.

9. A method of controlling a display apparatus in communication with an external device, the method comprising:
receiving a request from the external device to use a storage of the display apparatus;
determining whether the storage has available capacity in response to the request;
storing first data of the external device corresponding to the request in the storage if the available capacity of the storage is equal to or higher than a reference value; and
preventing the first data of the external device from being stored in the storage if the available capacity of the storage is lower than the reference value.

10. The method according to claim 9, wherein the preventing the first data from being stored in the storage comprises deleting second data of the external device previously stored in the storage.

11. The method according to claim 10, wherein the deleting the second data of the external device comprises deleting a plurality of pieces of second data previously stored in the storage based on priority information of the plurality of pieces of second data.

12. The method according to claim 9, wherein the preventing the first data from being stored in the storage comprises transmitting second data of the external device previously stored in the storage to the external device.

13. The method according to claim 9, wherein the determining whether the storage has available capacity comprises checking whether the display apparatus is in a standby mode, and storing the first data of the external device corresponding to the request in the storage if the display apparatus is in the standby mode.

14. The method according to claim 9, wherein the determining whether the storage has available capacity to store the first data of the external device corresponding to the request is based on capacity information, the capacity information being based on abut a ratio of the available capacity of the storage to total capacity of the storage.

15. The method according to claim 9, wherein the storing the first data in the storage comprises compressing the first data of the external device corresponding to the request and then storing the compressed first data in the storage.

16. The method according to claim 9, further comprising:
if the display apparatus is disconnected from the external device, separately storing data of the external device previously stored in the storage, in another storage; and
when the display apparatus resumes a connection with the external device, storing the separately stored data of the external device in the storage again.

17. A non-transitory computer readable recording medium to store executable computer instructions, that when executed, cause a computer to implement the method of claim 9.

18. A method of controlling a first electronic device in communication with an external electronic device, the method comprising:
receiving a request from the external electronic device to share a storage of the first electronic device to store first data of the external electronic device;
determining whether to store the first data in the storage based on an operating mode of the first electronic device; and
selectively storing the first data of the external electronic device corresponding to the request in the storage based on the determining.

19. The method according to claim 18, wherein if the operating mode of the first electronic device corresponds to a standby mode, the first electronic device automatically stores the first data in the storage.

20. The method according to claim 19, wherein if the operating mode of the first electronic device does not correspond to the standby mode, the determining further comprises determining whether to store the first data in the storage based on capacity information of the storage,
if the capacity information of the storage indicates an available capacity of the storage is equal to or greater than a predetermined reference value, the method comprises storing the first data in the storage, and
if the capacity information of the storage indicates an available capacity of the storage is less than a predetermined reference value, the method comprises preventing storage of the first data in the storage.
